(19) United States
(12) Patent Application Publication
(10) Pub. No.: US 2012/0136469 A1
(43) Pub. Date: May 31, 2012

(54) PRINTING PRESS CONTROL SYSTEM (XINK)

(76) Inventors: Michael Petersen, Rockcliffe (CA); Mykola Sherstyuk, Ottawa (CA); James Nielson, Ottawa (CA)

(21) Appl. No.: 12/279,956

(22) PCT Filed: Jun. 8, 2006
(86) PCT No.: PCT/CA2006/000940

§ 371 Date: Mar. 23, 2009

(30) Foreign Application Priority Data
Aug. 17, 2005 (CA) 2,516,141

(51) Int. Cl. G06F 17/00

(52) U.S. Cl. 700/110; 700/109

(57) ABSTRACT

A system for controlling the operation of a printing press used to apply an aqueous printable electrically conductive ink onto a substrate to create electrically conductive traces of such ink includes a probe for contacting the electrical traces and for obtaining a resistance measurement therefrom. A computer receives the resistance measurement, compares such measurement with pre-selected data correlating resistance with acceptable performance criteria for such traces, determines whether such resistance measurement signifies acceptable performance, and signals an appropriate mechanism for identifying those electrical traces which do not meet the acceptable performance criteria. Unacceptable traces are removed from the press prior to further processing. The computer can also signal an ink replenishment or conditioning system, contained in a replaceable cartridge, to correct any abnormalities in the ink properties.

The present invention relates to the control of a printing press operating to print electrical conductors formed of an aqueous printable dispersion on a substrate.

### BACKGROUND OF THE INVENTION

Commonly owned Canadian Patent Applications No. 2,509,608 of Jun. 9, 2005 and 2,528,420 of Nov. 30, 2006 describe an aqueous printable electrical conductor that can be printed on a substrate for use as RFID antennas and for other purposes. The conductor forms an electrical trace usable for such antennas, for printed medical, chemical and biological sensors, for printed touchpads, and for other related devices. Where such printed conductors are attached to CPUs (chips) as in the case of RFID tags, it is desirable for reasons of economy to know if the electrical characteristics of the printed conductor are within an acceptable range before a chip is attached. Since the chip is typically attached in-line with the high-speed printing process, the evaluation of the printed conductor and feedback must be rapid.

### SUMMARY OF THE INVENTION

The present invention is designed to evaluate the electrical characteristics of printed conductors such as, but not limited to, RFID antennas in-line during the printing process, to provide information as to whether the printed conductor is within an acceptable range of electrical characteristics, and to provide feedback to the system allowing chip attachment to be aborted if the conductor is not within specification. It is also designed to adjust the characteristics of the conductive ink being supplied to the printing press and other press characteristics in real time.

### BRIEF DESCRIPTION OF THE DRAWING

FIG. 1 is a block diagram illustrating schematically the process involved with the press control system of the present invention.

### DESCRIPTION OF THE PREFERRED EMBODIMENT

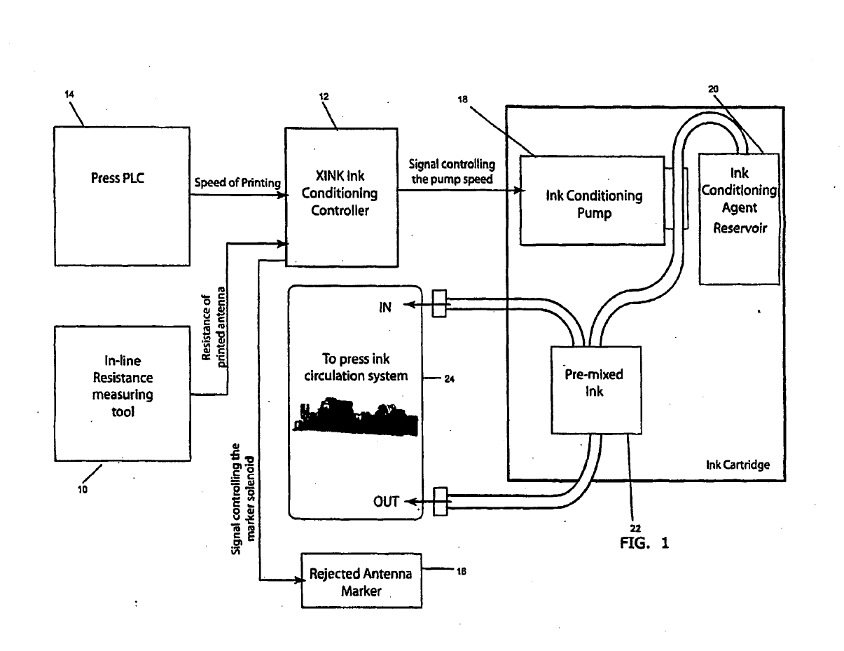

With reference to FIG. 1 the following explanation describes the use of the proposed invention in the high-speed printing of RFID antennas using conductive inks as described in the above-identified patent applications and the subsequent attachment of a chip to the antenna to make a completed RFID tag, all carried out on-line and in real time.

As the antennas come off the printer at high speed, the probes of the In-line Resistance Measuring Tool (IRMT) 10 contact the antenna and measure the resistance across it. The probes are located at the press in a location where the ink has dried to a point that contact by the probes will not damage the conductive trace. This location will likely vary from printing press to printing press, depending on the configuration thereof. The information obtained by the probes is fed to a computer-based Ink Conditioning Controller (ICC) 12. The ICC 12 also receives information about printing speed from the Press PLC 14. The ICC 12 then compares the data from the press to a pre-programmed Antenna Design File (ADF). The ADF contains information from the antenna designer about the measuring points on the antenna, the number of measurements per antenna and the range of measurement calculations that signify an acceptable antenna. The ICC 12 decides, on the basis of this comparison, whether an antenna is acceptable for chip attachment. Information on unacceptable antennas is sent to the Rejected Antenna Marker (RAM) 16 which marks, otherwise identifies, diverts or aborts the rejected antenna from the print process. Acceptable traces or antennas can be suitably marked with, for example, resistance measurements, or serial or lot numbers for inventory and quality control.

In parallel with the above process, the ICC 12 also compares the antenna resistance data to pre-programmed data correlating resistance data with ink quality, anilox roll surface, temperature, humidity, closed or open press ink reservoir and type of dryer in use on the press. If the ink quality requires adjustment, this information is sent to the Ink Conditioning Pump (ICP) 18. The ICP 18 then pumps an appropriate amount of Ink Conditioning Agent from the IC Reservoir 20 to the Pre-mix Reservoir 22, from which it is pumped to the press Ink Circulation System 24. The conditioner could alter different qualities or characteristics of the ink, a primary characteristic to be modified being the ink viscosity. The press Ink Circulation System 24 circulates ink through the Pre-mix Reservoir 22 to provide homogeneity of the ink supplies. This recirculation system maintains ink quality within design parameters as it flows through the press pipe lines and also takes into consideration abnormal ink usage, ensuring that a proper volume of ink is available for efficient operation of the press.

The data relating printed conductor resistance to press and press ink characteristics are stored in the ICC 12 where it can be selected at the beginning of each print run. The settings for successful runs can then be stored in the ICC 12 for future runs using the same substrate, ink, environmental and press characteristics.

The Ink Conditioning Pump 18, Ink Conditioning Agent Reservoir 20 and Pre-mix Reservoir 22 comprise a replaceable cartridge 30 that can be inserted into the press as required. The cartridge 30 is a separate non-reusable item which permits the press operator to produce high quality printed ink traces without having to understand the complex chemistry of conductive inks. The operator only has to insert a new cartridge when the old cartridge has served its purpose. The components of the cartridge are all tuned by the ink manufacturer for optimum performance of any particular press and printing operation.

What is claimed is:

1. A system for controlling the operation of a printing press used to apply an aqueous printable electrically conductive ink onto a substrate to create electrically conductive traces of such ink on such substrate, comprising:
probe means for contacting said electrical traces and for obtaining a resistance measurement therefrom;
computer means for receiving such resistance measurement, comparing such measurement with pre-selected data correlating resistance with acceptable predetermined performance criteria for such traces, determining whether such resistance measurement signifies acceptable performance, and signalling selection means for identifying those electrical traces which do not meet the acceptable performance criteria; and
means associated with said press for rejecting substrate having unacceptable electrical traces thereon from the press prior to further processing.

2. The system according to claim 1 wherein said electrical traces include RFID antennas, printed medical, chemical and biological sensors, printed touchpads and related devices.

3. The system according to claim 1 or claim 2 wherein said probe means contact the electrical traces at a predetermined point along the printing line where said traces are sufficiently dry that they will not be damaged by contact with said probe means.

4. The system according to any one of claims 1 to 3 wherein said rejecting means includes means for preventing the attachment of unacceptable electrical traces to a chip.

5. The system according to any one of claims 1 to 4 including printing means for applying information including but not limited to serial numbers and resistance measurements to acceptable substrate during the printing process to facilitate subsequent inventory control and quality assurance processes.

6. The system according to any one of claims 1 to 5 wherein said computer means is capable of signalling an ink replenishment system for correcting deficiencies in ink quality in real time during operation of said press following the correlation of said resistance measurement with said pre-selected data.

7. The system according to claim 6 wherein said ink replenishment system comprises an ink conditioning pump which receives control signals from said computer means, an ink conditioning agent reservoir connected to said pump and containing an ink conditioning agent, and an ink reservoir connected to an ink circulation system of said press, said pump feeding a controlled volume of conditioning agent to said ink reservoir so that ink flowing from said ink reservoir will exhibit acceptable performance criteria.

8. The system according to claim 7 wherein said ink conditioning agent is capable of altering the viscosity of the ink flowing from said ink reservoir to said press.

9. The system according to any one of claims 1 to 8 wherein said computer means is capable of correlating said resistance measurements with the operating conditions of the press and with the viscosity of the ink.

10. The system according to any one of claims 6 to 9 wherein the components of said ink replenishment system may be all contained within a replaceable cartridge that can be removably connected to said press.

11. A replenishment system for use with a printing press used to apply an aqueous printable conductive ink onto a substrate to create electrically conductive traces of such ink on the substrate, comprising:
an ink conditioning pump which receives control signals from a computer means;
an ink conditioning agent reservoir connected to said pump and containing an ink conditioning agent; and
an ink reservoir connected to an ink circulation system of said press, said pump being adapted to feed a controlled volume of said conditioning agent to said ink reservoir so that ink flowing from said ink reservoir will exhibit acceptable performance criteria as determined by said computer means.

12. The system of claim 11 wherein said ink conditioning agent is capable of altering the viscosity of the ink flowing from said ink reservoir to said press.

13. The system of claim 11 or claim 12 wherein said ink conditioning pump, said ink conditioning agent reservoir and said ink reservoir are contained within a replaceable cartridge that can be removably connected to said press.

14. A system for controlling the operation of a printing press used to apply an aqueous printable electrically conductive ink onto a substrate to create electrically conductive traces of such ink on such substrate, comprising:
probe means for contacting said electrical traces and for obtaining a resistance measurement therefrom;
an ink replenishment system containing an ink conditioning agent capable of correcting deficiencies in ink quality; and
computer means for receiving such resistance measurement, comparing such measurement with pre-selected data correlating resistance with predetermined acceptable performance criteria for such traces, determining whether such resistance measurement signifies a deficiency from such acceptable performance, and signalling said ink replenishment system to apply an appropriate amount of said ink conditioning agent to an ink circulation system of said press in order to correct such deficiency.

15. The system of claim 14 further comprising selection means for identifying those electrical traces which do not meet the acceptable performance criteria, and means for rejecting substrate having unacceptable electrical traces thereon form the press prior to further processing.

16. The system according to claim 14 or claim 15 wherein said probe means contact the electrical traces at a predetermined point along the printing line where said traces are sufficiently dry that they will not be damaged by contact with said probe means.

17. The system according to claim 15 wherein said rejecting means includes means for preventing the attachment of unacceptable electrical traces to a chip.

18. The system according to any one of claims 14 to 17 including printing means for applying information including but not limited to serial numbers and resistance measurements to acceptable substrate during the printing process to facilitate subsequent inventory control and quality assurance processes.

19. The system according to any one of claims 14 to 18 wherein said ink replenishment system comprises an ink conditioning pump which receives control signals from said computer means, an ink conditioning agent reservoir connected to said pump and containing said ink conditioning agent, and an ink reservoir connected to said ink circulation system of said press, said pump feeding a controlled volume of said ink conditioning agent to said ink reservoir so that ink flowing from said ink reservoir will exhibit acceptable performance criteria.

20. The system according to claim 19 wherein said ink conditioning agent is capable of altering the viscosity of the ink flowing from said ink reservoir to said press.

21. The system according to claim 20 wherein said computer means is capable of correlating said resistance measurements with the operating conditions of the press and the viscosity of the ink.

22. The system according to any one of claims 19 to 21 wherein said ink conditioning pump, said ink conditioning agent reservoir, and said ink reservoir are contained within a replaceable cartridge that can be removably connected to said press.

23. The system of claim 9 or claim 21 wherein said operating conditions include but are not limited to one or more of the operating temperature of the press, the humidity in the vicinity of the press, the anilox roil surface, the ink quality, and the type of dryer on the press.
